(19) United States
(12) Patent Application Publication
(10) Pub. No.: US 2015/0219306 A1
(43) Pub. Date: Aug. 6, 2015

(54) OPTICAL LENS AND BACKLIGHT ASSEMBLY INCLUDING THE SAME

(71) Applicant: Samsung Display Co. Ltd., Yongin-City (KR)

(72) Inventors: Sang Hoon LEE, Hwaseong-si (KR); Seong Yong HWANG, Asan-si (KR)

(21) Appl. No.: 14/324,538

(22) Filed: Jul. 7, 2014

(30) Foreign Application Priority Data
Feb. 4, 2014 (KR) 10-2014-0012663

(51) Int. Cl. F21V 5/04; F21V 23/00; G02F 1/1335

(52) U.S. Cl. CPC F21V 5/04; G02F 1/1336; F21V 23/005; F21Y 2105/001

(57) ABSTRACT

An optical lens includes, in a cross-sectional view, a bottom surface including: a lower flat portion, and a first groove recessed upwardly from the lower flat portion toward a top surface of the optical lens; the top surface including: a protruding upper spherical portion, and a second groove recessed downwardly from the upper spherical portion toward the bottom surface and at a location corresponding to the first groove; and a lateral surface including: a lateral flat portion and lateral curved portions, each of the lateral and curved portions connecting the lower flat portion of the bottom surface and the upper spherical portion of the top surface, to each other.

This application claims priority to Korean Patent Application No. 10-2014-0012663 filed on Feb. 4, 2014, and all the benefits accruing therefrom under 35 U.S.C. §119, the disclosure of which is incorporated herein by reference in its entirety.

### BACKGROUND

1. Field

Exemplary embodiments relate to an optical lens and a backlight assembly including the same.

2. Description of the Related Art

Liquid crystal displays (“LCDs”) have been widely used in display monitors, notebook computers, mobile phones, large-scale televisions (“TVs”), etc., because they are generally thin, light-weight and consume relatively less power than other display devices. An LCD includes an LCD panel, which displays an image by using the optical transmittance of liquid crystal molecules, and a backlight assembly, which is disposed below the LCD panel and provides light to the LCD panel.

The backlight assembly includes a plurality of light sources generating light for displaying the image on the LCD panel. For example, the light sources may be cold cathode fluorescent lamps (“CCFLs”), external electrode fluorescent lamps (“EEFLs”), flat fluorescent lamps (“FFLs”) or light-emitting diodes (“LEDs”).

LEDs, which boast of relatively low power consumption and environmental friendliness, have increasingly been used. For example, an LED module may include red, green and blue LED chips, and may output white light by mixing light provided by the red, green and blue LED chips, respectively.

The LED chips may provide a point light source-type distribution of light, and light with a point light source-type distribution may be converted to a surface light source-type distribution by an optical lens so as to be emitted over a predetermined area.

### SUMMARY

One or more exemplary embodiment provides a backlight assembly which is capable of controlling light that travels in a widthwise direction of a circuit board and adjusting the distribution of light so as to allow more light to be transmitted in a lengthwise direction of the circuit board.

One or more exemplary embodiment also provides an optical lens which is capable of controlling the distribution of light by controlling light that travels in a particular direction.

However, exemplary embodiments are not restricted to the one set forth herein. The above and other exemplary embodiments will become more apparent to one of ordinary skill in the art to which the invention concept pertains by referencing the detailed description of the exemplary embodiments given below.

According to one or more exemplary embodiment, there is provided an optical lens, in a cross-sectional view, including: a lower flat portion, and a first groove recessed upwardly from the lower flat portion toward a top surface of the optical lens; the top surface including: a protruding upper spherical portion, and a second groove recessed downwardly from the upper spherical portion toward the bottom surface and at a location corresponding to the first groove; and a lateral surface including: a lateral flat portion and lateral curved portions, each of the lateral and curved portions connecting the lower flat portion of the bottom surface and the upper spherical portion of the top surface, to each other. The optical lens, in a top plan view, has a long axis and a short axis, the lateral flat portion is at a side of the optical lens along the long axis, and the lateral curved portions are at opposing long axis ends of the optical lens.

The lateral flat portion may be perpendicular to the lower flat portion.

The lateral flat portion may be inclined at an inclination angle of about 90° or less with respect to the lower flat portion.

In a top plan view, the lateral surface may be a single looped curve including one or more straight line, and one or more curved line connected to the one or more straight line. The lateral flat portion of the lateral surface may include an odd number of straight lines, and the lateral curved portions of the lateral surface may be connected to each other by the odd number of straight lines.

The odd number of lines may include a single straight line parallel to the long axis.

The odd number of straight lines may include a first straight line that is parallel to the long axis, and second and third straight lines extended and bent from the first straight line toward the lateral curved portions.

According to one or more exemplary embodiment, there may be provided an optical lens, in a cross-sectional view, including: a lower flat portion, and a first groove recessed upwardly from the lower flat portion toward a top surface of the optical lens; the top surface including: a protruding upper spherical portion, and a second groove recessed downwardly from the upper spherical portion toward the bottom surface and at a location corresponding to the first groove; and a lateral surface including: first and second lateral flat portions and lateral curved portions, each flat and curved portion connecting the lower flat portion of the bottom surface and the upper spherical portion of the top surface, to each other. The optical lens in a top plan view, has a long axis and a short axis, the first and second lateral flat portions are at sides of the optical lens along the long axis, and the lateral curved portions are at opposing long axis ends of the optical lens.

The first and second lateral flat portions may be perpendicular to the lower flat portion.

The first lateral flat portion may be perpendicular to the lower flat portion and the second lateral flat portion may be inclined at an inclination angle of about 90° or less with respect to the lower flat portion.

The first and second lateral flat portions may be inclined at an inclination angle of about 90° or less with respect to the lower flat portion.

In a top plan view, the lateral surface may be a single looped curve including one or more straight line, and one or more curved line connected to the one or more straight line. Each of the first and second lateral flat portions may include an odd number of straight lines.

The odd number of straight lines of the first lateral flat portion may include a first straight line parallel to the long axis and second and third straight lines extended and bent from the first straight line toward the second lateral flat portion, and the odd number of straight lines of the second lateral flat portion may include a fourth straight line parallel to the long axis and fifth and sixth straight lines extended and bent from the fourth straight line toward the first lateral flat portion.

The first and second lateral flat portions may be symmetrical with respect to the long axis.

According to one or more exemplary embodiment, there may be provided a backlight assembly, including: a plurality of circuit boards each configured as a rectangular cuboid and be arranged in parallel with a predetermined distance from each other; an optical lens including: a bottom surface including a lower flat portion, and a first groove recessed upwardly from the lower flat portion toward a top surface of the optical lens, the top surface including a protruding upper spherical portion, and a second groove recessed downwardly from the upper spherical portion toward the bottom surface of the optical lens and at a location corresponding to the first groove, and a lateral surface including a lateral flat portion at a side of the optical lens along a widthwise direction of the plurality of circuit boards, and first lateral curved portions adjoining the lateral flat portion and aligned in a lengthwise direction of the plurality of circuit boards, each of the flat and curved portions connecting the lower flat portion of the bottom surface and the upper spherical portion of the top surface, to each other; a plurality of light source units arranged in rows in the lengthwise direction of the plurality of circuit boards, each including a light-emitting diode (“LED”) chip disposed in the first groove and electrically connected to one of the plurality of circuit boards; and a container configured to accommodate the plurality of circuit boards therein.

The lateral surface of the optical lens may further include a plurality of lateral flat portions disposed along the widthwise direction of the plurality of circuit boards and including: in a cross-sectional view, a first lateral flat portion perpendicular to the lower flat portion and a second lateral flat portion parallel to the first lateral flat portion.

The lateral surface of the optical lens may further include a plurality of lateral flat portions disposed along the widthwise direction of the plurality of circuit boards and including: in a cross-sectional view, a first lateral flat portion perpendicular to the lower flat portion and a second lateral flat portion with an inclination angle of 90° or less with respect to the lower flat portion.

The lateral surface of the optical lens may further include a plurality of lateral flat portions disposed along the widthwise direction of the plurality of circuit boards and including: in a cross-sectional view, a first lateral flat portion with an inclination angle of 90° or less with respect to the lower flat portion and a second lateral flat portion with an inclination angle of 90° or less with respect to the lower flat portion.

The lateral surface of the optical lens may further include a second lateral curved portion aligned with the lateral flat portion along the widthwise direction of the plurality of circuit boards, and the lateral flat portion may be perpendicular to the lower flat portion.

The lateral surface of the optical lens may further include a second lateral curved portion aligned with the lateral flat portion along the widthwise direction of the plurality of circuit boards, and the lateral flat portion may be inclined at an inclination angle of about 90° or less with respect to the lower flat portion.

The plurality of circuit boards may include an uppermost circuit board, an intermediate circuit board and a lowermost circuit board, sequentially in a top plan view. For each light source unit on the uppermost circuit board, the lateral flat portion may face the lowermost circuit board, for each light source unit on the lowermost circuit board, the lateral flat portion may face the uppermost circuit board, and for each light source unit disposed on the intermediate circuit board, the optical lens may further include a plurality of lateral flat portions including first and second lateral flat portions aligned in the widthwise direction of the plurality of circuit boards.

According to one or more exemplary embodiment, it is possible to provide an optical lens capable of controlling the distribution of light emitted in a predetermined direction.

Moreover, it is possible to provide a backlight assembly suitable for application to scanning and dimming technologies. In addition, since light can be concentrated in a lengthwise direction of circuit boards, it is possible to provide a backlight assembly suitable for driving only a row of light source units.

Other features will be apparent from the following detailed description, the drawings, and the claims.

### BRIEF DESCRIPTION OF THE DRAWINGS

The above and other features of the invention will become more apparent by describing in detail exemplary embodiments thereof with reference to the attached drawings, in which:

FIG. 1 is an exploded perspective view illustrating an exemplary embodiment of a backlight assembly according to the invention.

FIG. 2 is a cross-sectional view, taken along line II-IF of FIG. 1, of an exemplary embodiment of an optical lens according to the invention.

FIG. 3 is a cross-sectional view illustrating paths of light in and outside the optical lens of FIG. 2.

FIG. 4 is a cross-sectional view, taken along line IV-IV′ of FIG. 1, of the optical lens of FIG. 2.

FIG. 5 is a plan view illustrating portion A of FIG. 1.

FIG. 6 is a cross-sectional view illustrating another exemplary embodiment of an optical lens according to the invention.

FIG. 7 is a cross-sectional view illustrating still another exemplary embodiment of an optical lens according to the invention.

FIG. 8 is a cross-sectional view illustrating yet another exemplary embodiment of an optical lens according to the invention.

FIG. 9 is a cross-sectional view illustrating yet another exemplary embodiment of an optical lens according to the invention.

FIG. 10 is a plan view illustrating yet another exemplary embodiment of an optical lens according to the invention.

FIG. 11 is a plan view illustrating yet another exemplary embodiment of an optical lens according to the invention.

FIG. 12 is an exploded perspective view illustrating another exemplary embodiment of a backlight assembly according to another embodiment.

FIG. 13 is a cross-sectional view taken along line XIII-XIII′ of FIG. 12.

FIG. 14 illustrates illumination intensity measurements obtained by disposing a diffusion plate over a light source unit including a related-art optical lens, and measuring the intensity of light incident upon the diffusion plate.

FIG. 15 illustrates illumination intensity measurements obtained by disposing a diffusion plate over an exemplary embodiment of a light source unit including an optical lens according to the invention, and measuring the intensity of light incident upon the diffusion plate.

FIG. 16 illustrates illumination intensity measurements obtained by disposing a diffusion plate over another exemplary embodiment of a light source unit including an optical lens according to the invention, and measuring the intensity of light incident upon the diffusion plate.

FIG. 17 illustrates illumination intensity measurements obtained by disposing a diffusion plate over five light source units, each light source unit including a related-art optical lens, and measuring the intensity of light incident upon the diffusion plate.

FIG. 18 illustrates illumination intensity measurements obtained by disposing a diffusion plate over an exemplary embodiment of five light source units, each light source unit including an optical lens according to the invention, and measuring the intensity of light incident upon the diffusion plate.

FIG. 19 illustrates illumination intensity measurements obtained by disposing a diffusion plate over another exemplary embodiment of five light source units, each light source unit including an optical lens according to the invention, and measuring the intensity of light incident upon the diffusion plate.

### DETAILED DESCRIPTION

Advantages and features of the invention and methods of accomplishing the same may be understood more readily by reference to the following detailed description of exemplary embodiments and the accompanying drawings. The invention may, however, be embodied in many different forms and should not be construed as being limited to the exemplary embodiments set forth herein. Rather, these exemplary embodiments are provided so that this disclosure will be thorough and complete and will fully convey the invention to those skilled in the art, and the invention will only be defined by the appended claims. In the drawings, the thickness of layers and regions are exaggerated for clarity.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments will hereinafter be described with reference to the accompanying drawings.

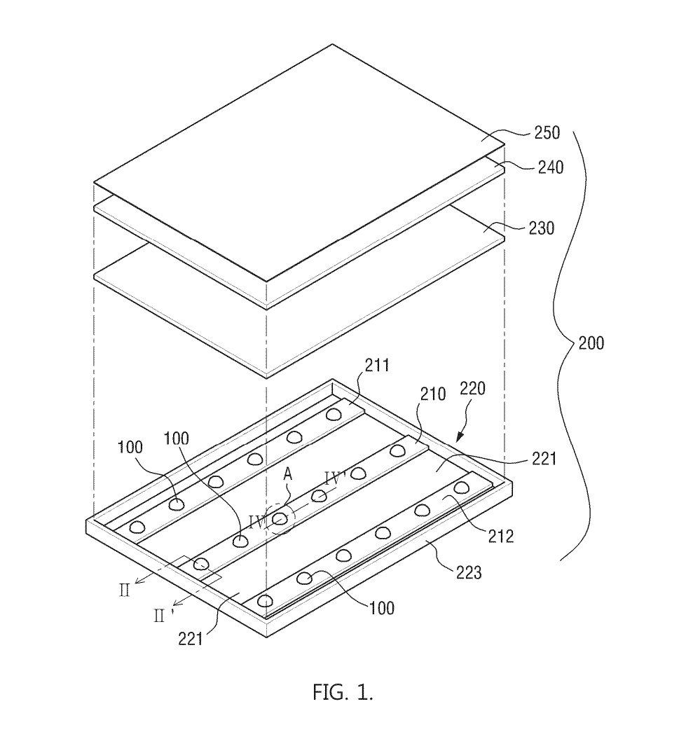

FIG. 1 is an exploded perspective view illustrating an exemplary embodiment of a backlight assembly according to the invention.

Referring to FIG. 1, a backlight assembly 200 may include a container 220, intermediate, upper and lower circuit boards 210, 211 and 212, and a plurality of light source units 100 mounted on each of the intermediate, upper and lower circuit boards 210, 211 and 212.

The intermediate, upper and lower circuit boards 210, 211 and 212 are relatively thin boards on which power lines (not illustrated) are disposed. In a (top) plan view, the intermediate, upper and lower circuit boards 210, 211 and 212 may be spaced from one another and may extend in parallel to one another. However, the number of circuit boards provided in the backlight assembly 200 is not limited to three. The intermediate, upper and lower circuit boards 210, 211 and 212 may be rectangular in the plan view. The intermediate, upper and lower circuit boards 210, 211 and 212 may be printed circuit boards (“PCBs”), metal coating PCBs (“MCPCBs”), which are PCBs coated with a metal with excellent thermal conductivity, or flexible PCBs (“FPCBs”), which are PCBs with flexibility. To drive the light source units 100, power may be applied from an external source (not illustrated) to the light source units 100 via the power lines on the intermediate, upper and lower circuit boards 210, 211 and 212, respectively.

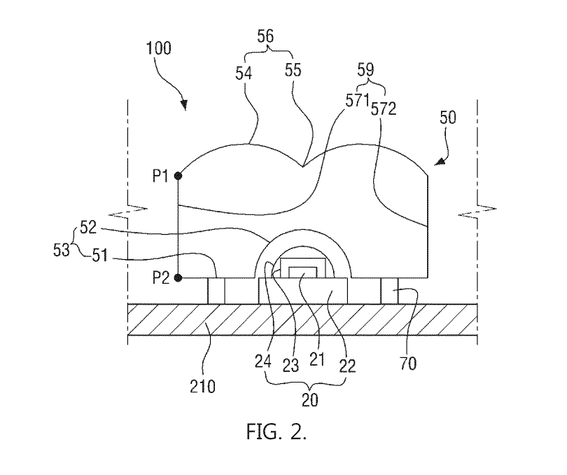

Five light source units 100 may be mounted on each of the intermediate, upper and lower circuit boards 210, 211 and 212, and each of the light source units 100 may include an optical lens (50 of FIG. 2). The optical lenses 50 of the light source units 100 will be described later in detail.

The light source units 100 may be disposed on the intermediate, upper and lower circuit boards 210, 211 and 212, and may generate light. The light source units 100 may be arranged in rows on the intermediate, upper and lower circuit boards 210, 211 and 212 in a lengthwise direction of the intermediate, upper and lower circuit boards 210, 211 and 212, e.g., a direction of line IV-IV′. The light source units 100 may be fixed onto the intermediate, upper and lower circuit boards 210, 211 and 212 by coupling terminals (not illustrated) with the intermediate, upper and lower circuit boards 210, 211 and 212. The light source units 100 will be described later in detail.

To accommodate the intermediate, upper and lower circuit boards 210, 211 and 212, to which the light source units 100 are coupled, the container 220 may include a bottom portion 221, and sidewalls 223 which extend from the edges of the bottom portion 221, and thus form a space for storage or for receiving other elements of the backlight assembly 200. The intermediate, upper and lower circuit boards 210, 211 and 212 may be disposed on the bottom portion 221 of the container 220. In a non-limiting exemplary embodiment, the container 220 may include a material such as metal with excellent rigidity that resists deformation. Alternatively, the container 220 may include a plastic material.

The backlight assembly 200 may also include a light guide member 230 which is disposed over the light source units 100. The light guide member 230 may be spaced from the light source units 100 by a predetermined distance, in a cross-sectional direction. In a non-limiting exemplary embodiment, the light guide member 230 may include polymethyl methacrylate (“PMMA”). In exemplary embodiments, the backlight assembly 200 may, or may not, include the light guide member 230.

The backlight assembly 200 may also include a diffusion plate 240 which is disposed over the light guide member 230. The diffusion plate 240 may be spaced from the light guide member 230 by a predetermined distance, in the cross-sectional direction. The diffusion plate 240 may improve the uniformity of luminance of light by diffusing light emitted from the light guide member 230. The diffusion plate 240 may be shaped as a plate with a predetermined cross-sectional thickness. In a non-limiting exemplary embodiment, the diffusion plate 240 may include polycarbonate (“PC”) or polystyrene (“PS”), and may include a diffusing agent for diffusing light. The diffusion plate 240 may also include a plurality of diffusion patterns for further uniformly diffusing light supplied thereto.

The backlight assembly 200 may also include an optical sheet 250 with a variety of functions, depending on the luminous properties required. In a non-limiting exemplary embodiment, the optical sheet 250 may be a prism sheet which concentrates light emitted from the diffusion plate 240 so as for the light to be transmitted upward or toward a liquid crystal panel (not illustrated). The prism sheet may include a vertical prism sheet, which concentrates light in a vertical direction, and/or a horizontal prism sheet, which concentrates light in a horizontal direction.

FIG. 2 is a cross-sectional view, taken along line II-II′ of FIG. 1, of an exemplary embodiment of an optical lens according to the invention.

Referring to FIG. 2, a light source unit 100 may include a light-emitting device package 20, and the optical lens 50 disposed on the light-emitting device package 20.

The light-emitting device package 20 may include a package body 21, a light-emitting diode (“LED”) chip 22, a phosphor layer 23 surrounding the LED chip 22, and an encapsulating resin layer 24 surrounding the phosphor layer 23 on the package body 21.

A terminal (not illustrated) may be disposed on the package body 21. More specifically, the terminal may be extended through the package body 21 or on the surface of the package body 21. The terminal may electrically connect the LED chip 22 and the underlying intermediate circuit board 210. The package body 21 may include various materials. In a non-limiting exemplary embodiment, the package body 21 may include one of a ceramic material, a resin material and a silicon material.

The LED chip 22 may be installed on the package body 21. In a non-limiting exemplary embodiment, One LED chip 22 may be installed on the package body 21, as illustrated in FIG. 2. In another non-limiting exemplary embodiment, a plurality of LED chips 22 may be installed on the package body 21 and may be connected in series or in parallel to one another, and may be electrically connected to the terminal by flip chip bonding or wire bonding. At least one of a red LED chip, a green LED chip and a blue LED chip may be used as the LED diode chip(s) 22.

The phosphor layer 23 may be disposed to surround the LED chip 22 on the package body 21. In a non-limiting exemplary, the phosphor layer 23 may include a yellow phosphor. The phosphor layer 23 may have a flat top surface, and may be extended to a predetermined height from the package body 21.

The encapsulating resin layer 24 may be disposed on the package body 21, and may surround the phosphor layer 23. The encapsulating resin layer 24 may include a transparent resin material such as, for example, an epoxy resin or a silicon resin. The encapsulating resin layer 24 may be disposed such that a central portion of the top surface of the encapsulating resin layer 24 may protrude, and that the rest of the top surface of the encapsulating resin layer 24 may be flat.

The optical lens 50 may include a bottom surface 53, a top surface 56 and a lateral surface 59. The optical lens 50 may include a transparent resin material. The optical lens 50 may also include one or more lens supporting units 70. The lens supporting unit 70 may protrude from the bottom surface 53. The optical lens 50 may include a plurality of lens supporting units 70. The optical lens 50 is illustrated in FIG. 2 as having two lens supporting units 70, but the optical lens 50 may actually include one, three or four lens supporting units 70. The lens supporting units 70 may be spaced from each other, and may be disposed on the bottom surface 53. In an exemplary embodiment of manufacturing the optical lens 50, the lens supporting units 70 may be formed integral with another element of the optical lens 50 by, for example, injection molding, or may be formed as a separate element and may then be coupled to another element of the optical lens 50 by, for example, by bonding. The lens supporting units 70 may be attached onto the intermediate circuit board 210 by an adhesive (not illustrated).

In the exemplary embodiment of FIG. 2, the light-emitting package 20 may be fabricated by packaging the LED chip 22, but the invention is not limited to the exemplary embodiment of FIG. 2. That is, the LED chip 22 may be directly mounted on the intermediate circuit board 210 by chip-on-board technology.

The bottom surface 53 may include a lower flat portion 51, and a first groove 52 which extends from the lower flat portion 51 and is recessed upwardly toward the top surface 56. The first groove 52 may be configured to accommodate the LED chip 22 therein. That is, the LED chip 22 may be disposed in the first groove 52.

The top surface 56 may include an upper spherical portion 54, and a second groove 55 which extends from the upper spherical portion 54 and is recessed downwardly toward the bottom surface 53. The second groove 55 may be disposed at a location corresponding to the first groove 52 by being recessed downwardly from the upper spherical portion 54 toward the bottom surface 53. The second groove 55 may be optional. In an alternative exemplary embodiment, the second groove 55 may be defined as an opening in the bottom surface 53.

The lateral surface 59 may include a first lateral flat portion 571, a second lateral flat portion 572 and lateral curved portions (not illustrated). The lateral surface 59 may connect the lower flat portion 51 and the upper spherical portion 54. The lateral surface 59 may be defined as an area between a first point P1 and a second point P2. The first point P1 may be a point of contact between the first lateral flat portion 571 and the upper spherical portion 54, and the second point P2 may be a point of contact between the first lateral flat portion 571 and the lower flat portion 51.

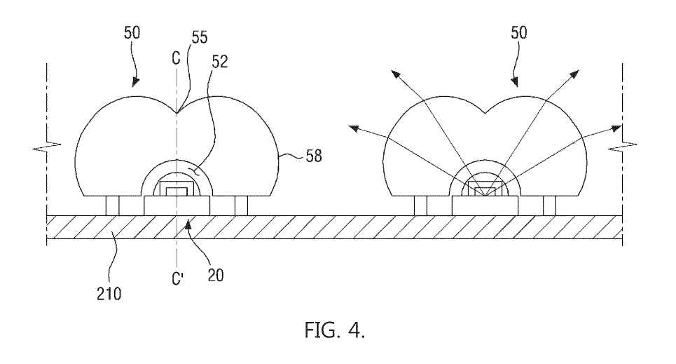

The first lateral flat portion 571 and the second lateral flat portion 572 may be aligned in a widthwise direction of the intermediate circuit board 210, e.g., a direction of line II-IF of FIG. 1. The lateral curved portions may be aligned in a lengthwise direction of the intermediate circuit board 210, e.g., the direction of line IV-IV′ of FIG. 1. The lateral curved portions may account for the entire lateral surface 59 except for the first lateral flat portion 571 and the second lateral flat portion 572. That is, the lateral curved portions may be provided at the front and the rear of the optical lens 50. The lateral curved portions may adjoin the first lateral flat portion 571 and the second lateral flat portion 572. The lateral curved portions may connect the lower flat portion 51 and the upper spherical portion 54 while adjoining the first lateral flat portion 571 and the second lateral flat portion 572. The lateral curved portions will be described later in further detail with reference to FIG. 4.

The first lateral flat portion 571 may connect a first end of the upper spherical portion 54 and a first end of the lower flat portion 51, and the second lateral flat portion 572 may connect an opposing second end of the upper spherical portion 54 and an opposing second end of the lower flat portion 51. The first lateral flat portion 571 and the second lateral flat portion 572 may be surfaces perpendicular to the lower flat portion 51.

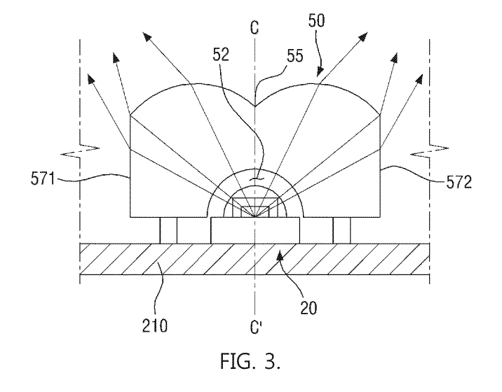

FIG. 3 is a cross-sectional view illustrating paths of light in and outside the optical lens of FIG. 2. More specifically, FIG. 3 mimetically illustrates paths of light in and outside the optical lens of FIG. 2 by using arrows.

Referring to FIG. 3, light that arrives at the first lateral flat portion 571 or the second lateral flat portion 572, which is perpendicular to the lower flat portion 51, from the LED chip 22 may be emitted from the first lateral flat portion 571 or the second lateral flat portion 572 in a direction where the light becomes closer to an imaginary central axis C-C′ passing through the first groove 52 and the second groove 55, e.g., a direction where the light may converge on the imaginary central axis C-C′. That is, the light that arrives at the first lateral flat portion 571 or the second lateral flat portion 572 may be refracted vertically upward or toward a liquid crystal display panel (not illustrated), instead of spreading out horizontally.

Light that arrives at the upper spherical portion 54 from the LED chip 22 may be emitted in a direction where the light may become more distant from the imaginary central axis C-C′, e.g., in a direction where the light may diverge from the imaginary central axis C-C′. That is, the light that arrives at the upper spherical portion 54 from the LED chip 22 may be emitted horizontally, instead of being refracted vertically upward or toward the liquid crystal panel.

FIG. 4 is a cross-sectional view, taken along line IV-IV′ of FIG. 1, of the optical lens of FIG. 2. FIG. 4 also illustrates paths of light in and outside the optical lens of FIG. 2 mimetically by using arrows.

Referring to FIG. 4, when viewed along line IV-IV′ of FIG. 1, unlike when viewed along line II-II′ of FIG. 1, the first lateral flat portion 571 and the second lateral flat portion 572 of the lateral surface 59 are not visible. Instead, lateral curved portions 58 of the lateral surface 59 are visible when the optical lens 50 is viewed along line IV-IV′. The lateral curved portions 58 may be aligned in the lengthwise direction of the intermediate circuit board 210. Line IV-IV′ may be parallel to the lengthwise direction of the intermediate circuit board 210.

Light that arrives at the lateral curved portions 58, which have a predetermined curvature, from the LED chip 22 may be emitted from the lateral curved portions 58 in a direction where the light may diverge from the imaginary central axis C-C′. That is, the light that arrives at the lateral curved portions 58 may be refracted to spread out horizontally. Since the lateral curved portions 58 may be aligned in the lengthwise direction of the intermediate circuit board 210, light may be concentrated in the lengthwise direction of the intermediate circuit board 210.

More specifically, two light source units 100 are illustrated in FIG. 4 as being arranged in a row in the lengthwise direction of the intermediate circuit board 210. The two light source units 100 may be spaced from each other by a predetermined distance and may be disposed in such a manner that their lateral curved portions 58 may face each other. Since light emitted from the lateral curved portions 58 may be refracted in the lengthwise direction of the intermediate circuit board 210, the backlight assembly 200 may concentrate light, emitted from the LED chip 22, in the lengthwise direction of the intermediate circuit board 210. That is, an amount of light in the lengthwise direction of the intermediate circuit board 210 may be more than that in a widthwise direction of the intermediate circuit board 210.

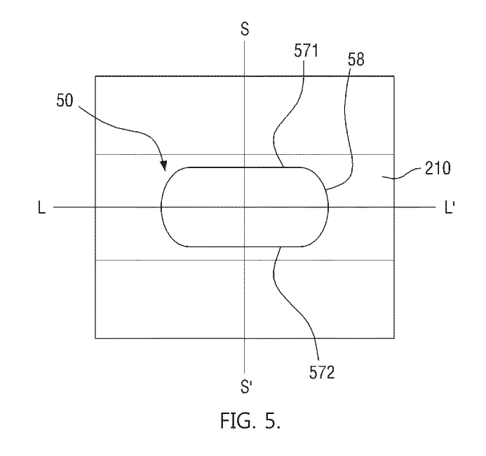

FIG. 5 is a plan view illustrating portion A of FIG. 1.

Referring to FIG. 5, an outer edge of a light source unit 100 may appear from above to form a single looped curve consisting of two curved lines and two straight lines. The looped curve may have a long axis L-L′ and a short axis S-S′. The two curved lines may be projection lines of the lateral curved portions 58, and the two straight lines may be projection lines of the first lateral flat portion 571 and the second lateral flat portion 572. For convenience, the two curved lines will hereinafter be referred to by reference numeral 58, and the two straight lines will hereinafter be referred to by reference numerals 571 and 572, respectively.

The two straight lines 571 and 572 may be parallel to the long axis L-L′, and the long axis L-L′ may be parallel to the lengthwise direction of the intermediate circuit board 210. The two curved lines 58 may connect the two straight lines 571 and 572 together and may thus form a looped curve in the plan view.

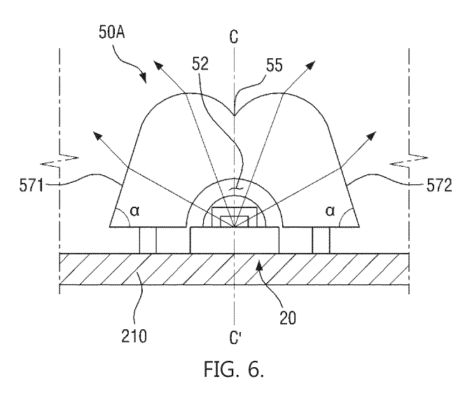

FIG. 6 is a cross-sectional view illustrating another exemplary embodiment of an optical lens according to another embodiment.

Referring to FIG. 6, an optical lens 50A is different from the optical lens 50 of FIG. 2 in that a first lateral flat portion 571 and a second lateral flat portion 572 are both at an inclination angle α of 90° or less with respect to a lower flat portion 51. In FIG. 6, paths of light in and outside the optical lens 50A are mimetically illustrated with arrows. As illustrated in FIG. 6, in the exemplary embodiment of FIG. 6, like in the exemplary embodiment of FIG. 3, light that arrives at the first lateral flat portion 571 or the second lateral flat portion 572 from an LED chip 22 may be refracted from the first lateral flat portion 571 or the second lateral flat portion 572 in a direction where the light may converge on an imaginary central axis C-C′ passing through a first groove 52 and a second groove 55.

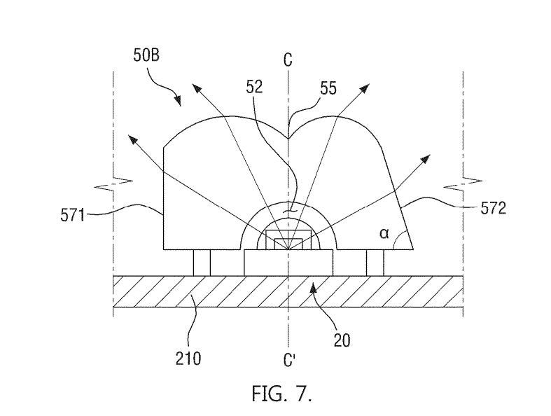

FIG. 7 is a cross-sectional view illustrating still another exemplary embodiment of an optical lens according to the invention.

Referring to FIG. 7, an optical lens 50B is different from the optical lens 50 of FIG. 2 in that only a second lateral flat portion 572 among first and second lateral flat portions 571 and 572 is at an inclination angle α of 90° or less with respect to a lower flat portion 51.

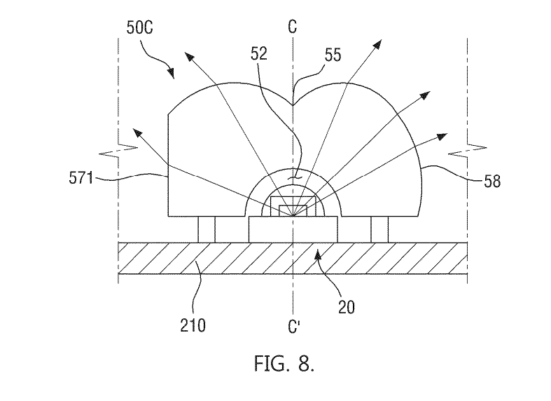

FIG. 8 is a cross-sectional view illustrating yet another exemplary embodiment of an optical lens according to the invention.

Referring to FIG. 8, an optical lens 50C is different from the optical lens 50 of FIG. 2 in that a lateral curved portion 58 is formed to replace a second lateral flat portion 572. That is, in a widthwise direction of the intermediate circuit board 210, an upper spherical portion 54 and a lower flat portion 51 may be connected by a first lateral flat portion 571 at one side portion and the lateral curved portion 58 at the opposing side portion.

In FIG. 8, paths of light in and outside the optical lens 50C are mimetically illustrated with arrows. As illustrated in FIG. 8, in the exemplary embodiment of FIG. 8, like in the exemplary embodiment of FIG. 3, light that arrives at the first lateral flat portion 571, which is perpendicular to the lower flat portion 51, from an LED chip 22 may be emitted from the first lateral flat portion 571 in a direction where the light may converge on an imaginary central axis C-C′ passing through a first groove 52 and a second groove 55.

In the optical lens 50C, light that arrives at the first lateral flat portion 571 may be concentrated upward, instead of diverging from the imaginary central axis C-C′, and light that arrives at the lateral curved portion 58 may diverge from the imaginary central axis C-C′. Accordingly, it is possible to design a backlight assembly to selectively control the distribution of light to be emitted or spread out into a region where the first lateral flat portion 571 is aligned.

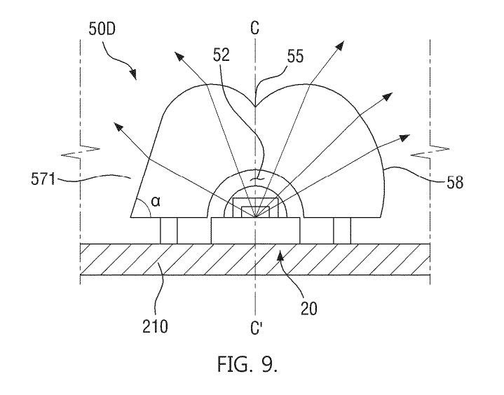

FIG. 9 is a cross-sectional view illustrating yet another exemplary embodiment of an optical lens according to the invention.

Referring to FIG. 9, an optical lens 50D is different from the optical lens 50C of FIG. 8 in that a first lateral flat portion 571 is at an inclination angle α of 90° or less with respect to a lower flat portion 51.

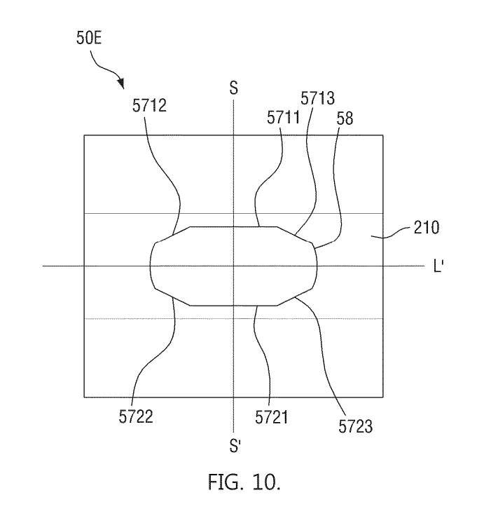

FIG. 10 is a plan view illustrating yet another exemplary embodiment of an optical lens according to the invention.

Referring to FIG. 10, an optical lens 50E is different from the optical lens 50 of FIG. 5 in that an outer edge of the optical lens 50E may appear from above to form a looped curve consisting of two curved lines and six straight lines. The two curved lines may be projection lines of lateral curved portions 58, and the six straight lines may be projection lines of each of a first lateral flat portion 571 and a second lateral flat portion 572. More specifically, the first lateral flat portion 571 may be projected as a series of straight lines including a first straight line 5711, which is parallel to a long axis L-L′, and a second straight line 5712 and a third straight line 5713, which are extended and bent from either end of the first straight line 5711 toward the lateral curved portions 58, respectively. The second lateral flat portion 572 may be projected as a series of straight lines including a fourth straight line 5721, which is parallel to the long axis L-L′, and a fifth straight line 5722 and a sixth straight line 5723, which are extended and bent from either end of the fourth straight line 5721 toward their respective lateral curved portions 58.

The first lateral flat portion 571 and the second lateral flat portion 572 may be symmetrical with respect to the long axis L-L′. That is, the first straight line 5711, the second straight line 5712 and the third straight line 5713 of the first lateral flat portion 571 may be symmetrical to the fourth straight line 5721, the fifth straight line 5722 and the sixth straight line 5723, respectively, of the second lateral flat portion 572 with respect to the long axis L-L′.

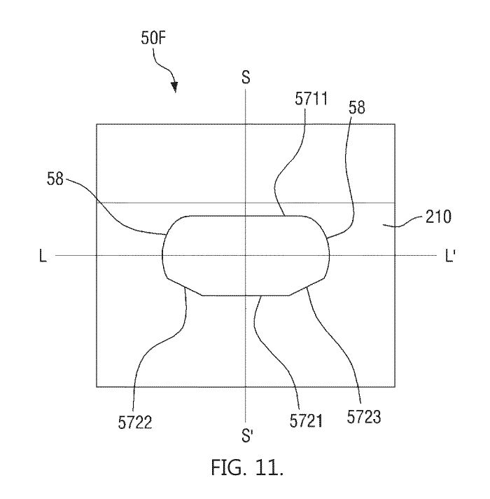

FIG. 11 is a plan view illustrating yet another exemplary embodiment of an optical lens according to the invention.

Referring to FIG. 11, an optical lens 50F is different from the optical lens 50E of FIG. 10 in that a first lateral flat portion 571 is projected only as a first straight line 5711, and a second lateral flat portion 572 is projected as a series of straight lines including a fourth straight line 5721, a fifth straight line 5722 and a sixth straight line 5723. That is, the optical lens 50F, unlike the optical lens 50E, is not symmetrical with respect to a long axis L-L′.

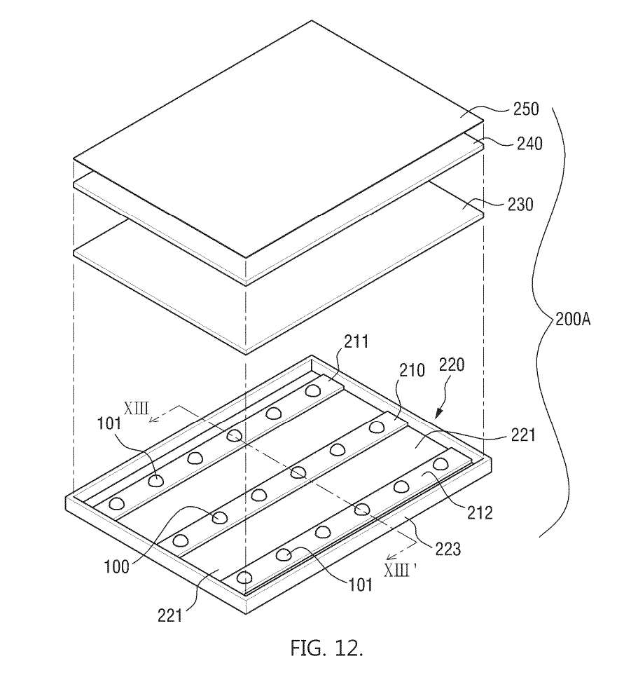

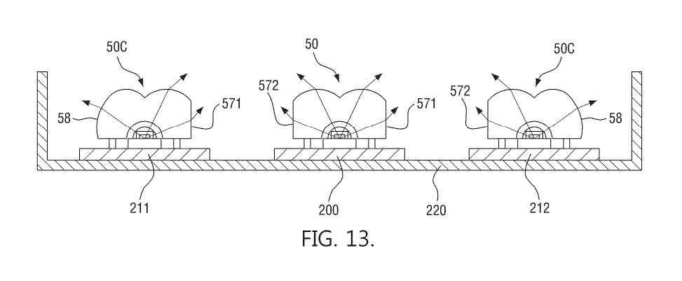

FIG. 12 is an exploded perspective view illustrating another exemplary embodiment of a backlight assembly according to the invention, and FIG. 13 is a cross-sectional view taken along line XIII-XIII′ of FIG. 12.

Referring to FIGS. 12 and 13, a backlight assembly 200A is different from the backlight assembly 200 of FIG. 1 in that each of a plurality of light source units 101, which are arranged on an upper circuit board 211 or a lower circuit board 212, includes an optical lens 50C.

More specifically, as illustrated in FIG. 13, in a light source unit 101 arranged on the upper circuit board 211, an optical lens 50C may be arranged so as for a first lateral flat portion 571 thereof to face the lower circuit board 212, and in a light source unit 101 arranged on the lower circuit board 212, an optical lens 50C may be arranged so as for a first lateral flat portion 571 thereof to face the upper circuit board 211. Each of the optical lenses 50C may include a first lateral flat portion 571, and a lateral curved portion 58 which is opposite to the first lateral flat portion 571, and the lateral curved portion 58 may overlap a bezel area of a display device. That is, the first lateral flat portions 571 of the outermost circuit boards 211 and 212 face toward an inner area of the backlight assembly 200A. Conversely, the lateral curved portions 58 of the outermost circuit boards 211 and 212 face toward an outer area of the backlight assembly 200A.

As illustrated in FIG. 13, in a light source unit 101 disposed on an intermediate circuit board 210, an optical lens 50 may be arranged so as for a first lateral flat portion 571 and a second lateral flat portion 572 thereof to be aligned in a widthwise direction of the intermediate circuit board 210, which is disposed between the upper circuit board 211 and the lower circuit board 212. That is, at the intermediate circuit board 210, the light source units 101 include the first and second lateral flat portions 571 and 572 facing toward the outer area of the backlight assembly 200A.

The first lateral flat portion 571 of the optical lenses 50C of the light source units 101 on the upper circuit board 211 may face the second lateral flat portions 572 of the optical lenses 50 of the light source units 101 on the intermediate circuit board 210. The second lateral flat portion 572 of the optical lenses 50C of the light source units 101 on the lower circuit board 212 may face the first lateral flat portions 571 of the optical lenses 50 of the light source units 101 on the intermediate circuit board 210.

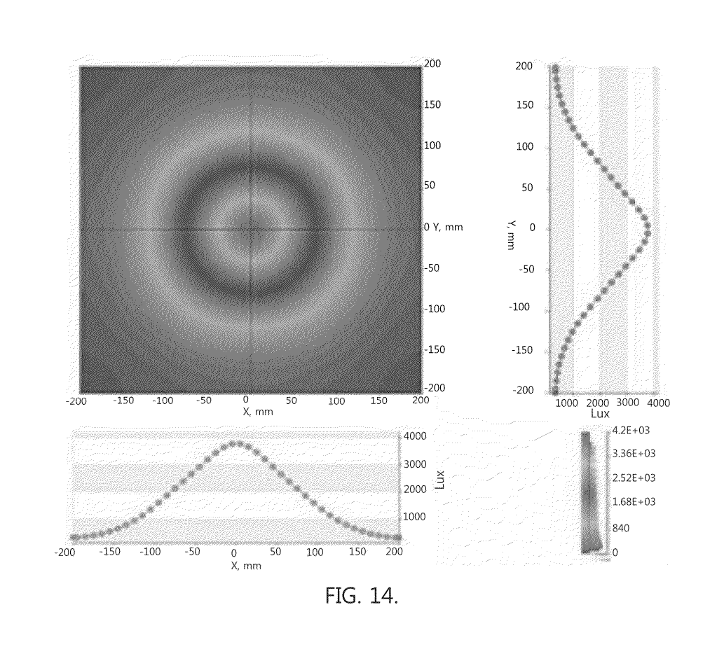

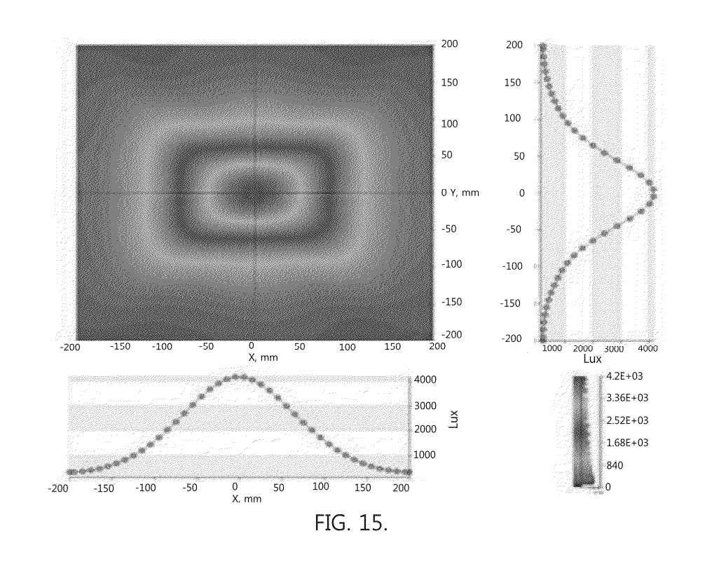

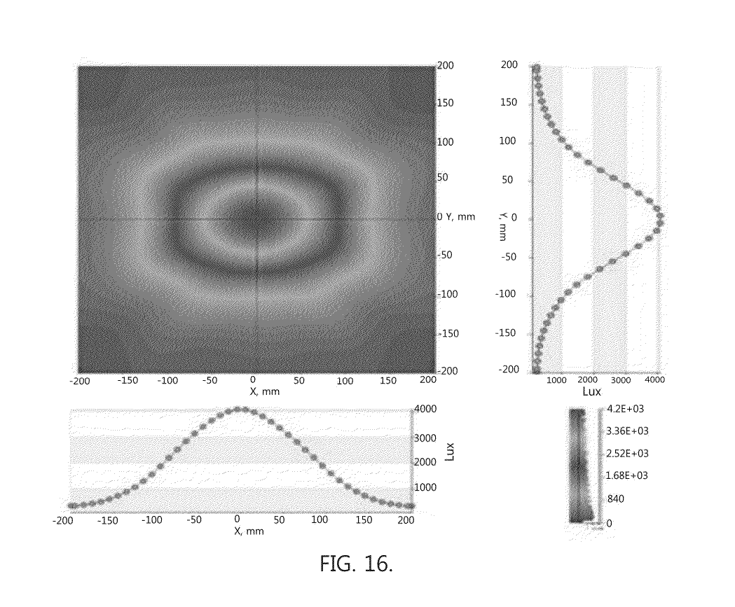

FIG. 14 illustrates illumination intensity measurements obtained by disposing a diffusion plate over a light source unit including a related-art optical lens with a full width half maximum of 140 millimeters (FWHM: 140 mm) and measuring the intensity of light incident upon the diffusion plate, FIG. 15 illustrates illumination intensity measurements obtained by disposing a diffusion plate over a light source unit including an optical lens 50 (FWHM: 160 mm (horizontal), 100 mm (vertical)) and measuring the intensity of light incident upon the diffusion plate, and FIG. 16 illustrates illumination intensity measurements obtained by disposing a diffusion plate over a light source unit including an optical lens 50E (FWHM: 170 mm (horizontal), 110 mm (vertical)) and measuring the intensity of light incident upon the diffusion plate.

Referring to FIGS. 15 and 16, in the case of a light source unit including an optical lens 50 or 50E, the length of the distribution of light in a horizontal direction (e.g., a direction of the long axis of the optical lens 50 or 50E) is greater than the length of the distribution of light in a vertical direction (e.g., a direction of the short axis of the optical lens 50 or 50E) because light emitted from an LED chip of the light source unit is refracted and emitted out of the optical lens 50 or 50E through the lateral curved portion of the optical lens 50 or 50E in the direction of the long axis of the optical lens 50 or 50E, e.g., in the horizontal direction. That is, the amount of light traveling in the horizontal direction is greater than the amount of light traveling in the vertical direction.

On the other and, referring to FIG. 14, in the case of the related-art optical lens where a light source unit not including the optical lens 50 or 50E, the length of the distribution of light in the vertical direction and the length of the distribution of light in the horizontal direction are almost identical.

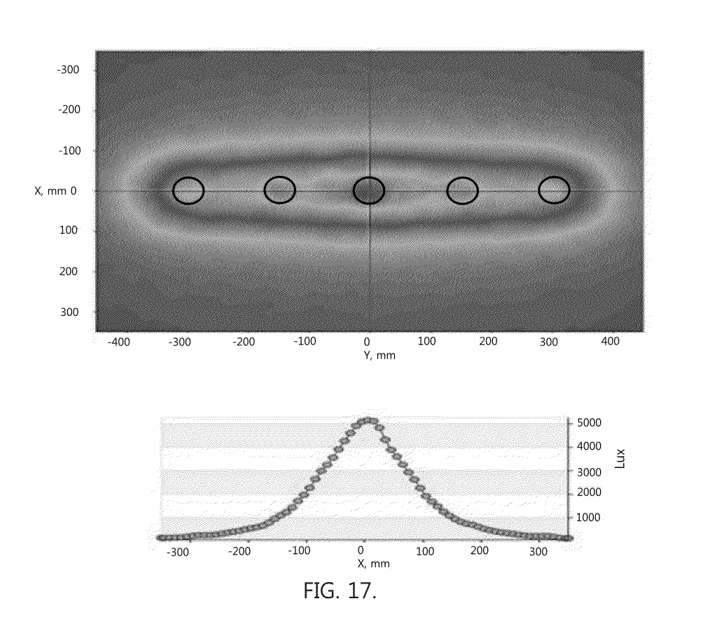

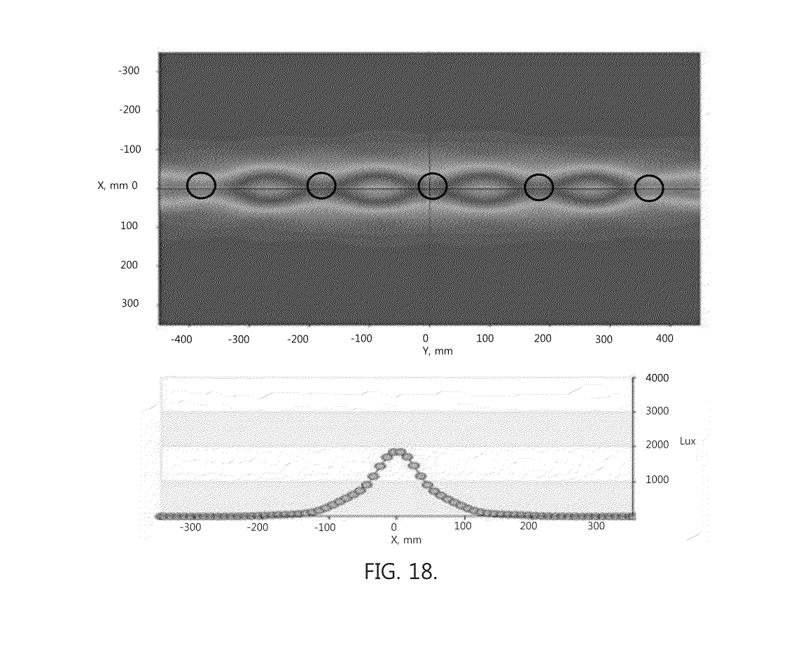

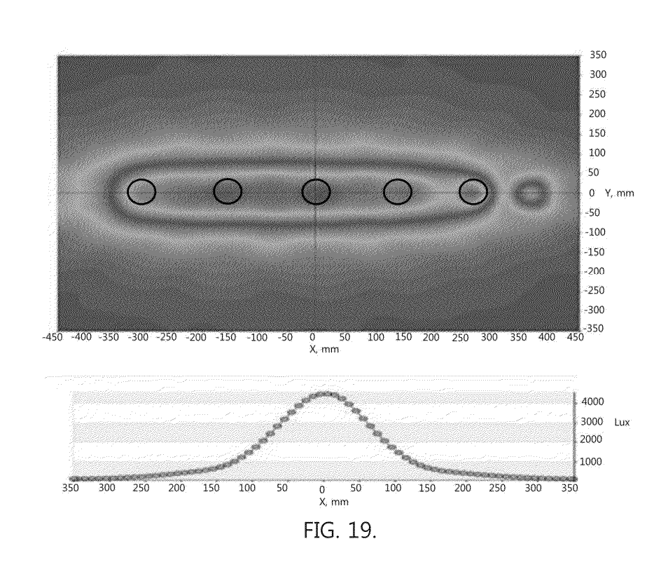

FIG. 17 illustrates illumination intensity measurements obtained by disposing a diffusion plate over five light source units, each light source unit including a related-art optical lens (FWHM: 170 mm (vertical)), and measuring the intensity of light incident upon the diffusion plate, FIG. 18 illustrates illumination intensity measurements obtained by disposing a diffusion plate over five light source units, each light source unit including an optical lens 50 (FWHM: 100 mm (vertical)), and measuring the intensity of light incident upon the diffusion plate, and FIG. 19 illustrates illumination intensity measurements obtained by disposing a diffusion plate over five light source units, each light source unit including an optical lens 50E (FWHM: 110 mm (horizontal), and measuring the intensity of light incident upon the diffusion plate.

Referring to FIG. 18, light is distributed to form a long horizontal pattern among five light sources (marked by circles), which are arranged in a row in a horizontal direction. That is, light is concentrated in the horizontal direction.

Similarly, referring to FIG. 19, light is distributed to form a long continuous horizontal pattern across five light sources (marked by circles), which are arranged in a row in a horizontal direction. That is, light is concentrated in among the five light source units.

On the other hand, referring to FIG. 17, no such patterns of distribution of light as those shown in FIGS. 18 and 19, are found among five light source units (marked by circles), which are arranged in a row in the horizontal direction, because in the case of a related-art optical lens, the area of the distribution of light in the horizontal direction is almost the same as the area of the distribution of light in a vertical direction, as shown in FIG. 14. That is, a horizontal array of five related-art optical lenses, unlike a horizontal array of five optical lenses of an exemplary embodiment according to the invention, cannot reduce the amount of light that travels in the vertical direction.

Although exemplary embodiments have been described with reference to a number of illustrative exemplary embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An optical lens, comprising:
in a cross-sectional view,
a bottom surface comprising:
a lower flat portion, and
a first groove recessed upwardly from the lower flat portion toward a top surface of the optical lens;
the top surface comprising:
a protruding upper spherical portion, and
a second groove recessed downwardly from the upper spherical portion toward the bottom surface and at a location overlapping the first groove; and
a lateral surface comprising:
a lateral flat portion and a lateral curved portion,
each of the lateral and curved portion connecting the lower flat portion of the bottom surface and the upper spherical portion of the top surface, to each other.

2. The optical lens of claim 1, wherein in a cross-sectional view, the lateral flat portion is perpendicular to the lower flat portion of the bottom surface.

3. The optical lens of claim 1, wherein in a cross-sectional view, the lateral flat portion is inclined at an inclination angle of about 90° or less with respect to the lower flat portion of the bottom surface.

4. The optical lens of claim 1, wherein in a top plan view,
the lateral surface is a single looped curve comprising one or more straight line, and one or more curved line connected to the one or more straight line,
the lateral flat portion of the lateral surface comprises an odd number of straight lines, and
the lateral curved portions of the lateral surface are connected to each other by the odd number of straight lines.

5. The optical lens of claim 4, wherein the odd number of lines of the lateral flat portion comprises a single straight line parallel to the long axis of the optical lens.

6. The optical lens of claim 4, wherein the odd number of straight lines of the lateral flat portion comprises:
a first straight line parallel to the long axis of the optical lens, and
second and third straight lines extended and bent from the first straight line toward the lateral curved portions of the lateral surface.

7. An optical lens, comprising:
in a cross-sectional view,
a bottom surface comprising:
a lower flat portion, and
a first groove recessed upwardly from the lower flat portion toward a top surface of the optical lens;
the top surface comprising:
a protruding upper spherical portion, and
a second groove recessed downwardly from the upper spherical portion toward the bottom surface and at a location overlapping the first groove; and
a lateral surface comprising a first and a second lateral flat portion, each the first and second flat portion connecting the lower flat portion of the bottom surface and the upper spherical portion of the top surface, to each other.

8. The optical lens of claim 7, wherein in a cross-sectional view, the first and second lateral flat portions are perpendicular to the lower flat portion of the bottom surface.

9. The optical lens of claim 7, wherein in a cross-sectional view,
the first lateral flat portion is perpendicular to the lower flat portion, and
the second lateral flat portion is inclined at an inclination angle of about 90° or less with respect to the lower flat portion of the bottom surface.

10. The optical lens of claim 7, wherein in a cross-sectional view, the first and second lateral flat portions are inclined at an inclination angle of 90° or less with respect to the lower flat portion.

11. The optical lens of claim 7, wherein in a top plan view,
the lateral surface is a single looped curve comprising one or more straight line, and one or more curved line connected to the one or more straight line,
each of the first and second lateral flat portions comprises an odd number of straight lines.

12. The optical lens of claim 11, wherein
the odd number of straight lines of the first lateral flat portion comprises:
a first straight line parallel to the long axis of the optical lens, and
second and third straight lines extended and bent from the first straight line toward the second lateral flat portion, and
the odd number of straight lines of the second lateral flat portion comprises:
a fourth straight line parallel to the long axis of the optical lens, and
fifth and sixth straight lines extended and bent from the fourth straight line toward the first lateral flat portion.

13. The optical lens of claim 12, wherein the first and second lateral flat portions are symmetrical with respect to the long axis of the optical lens.

14. A backlight assembly, comprising:
a plurality of circuit boards each configured as a rectangular cuboid, and arranged in parallel with each other and at a predetermined distance from each other;
an optical lens comprising:
a bottom surface comprising a lower flat portion, and a first groove recessed upwardly from the lower flat portion toward a top surface of the optical lens,
the top surface comprising a protruding upper spherical portion, and a second groove recessed downwardly from the upper spherical portion toward the bottom surface of the optical lens and at a location corresponding to the first groove, and
a lateral surface comprising a lateral flat portion at a side of the optical lens along a widthwise direction of the plurality of circuit boards, and first lateral curved portions adjoining the lateral flat portion and aligned in a lengthwise direction of the plurality of circuit boards, each of the flat and curved portions connecting the lower flat portion of the bottom surface and the upper spherical portion of the top surface, to each other;
a plurality of light source units arranged in rows in the lengthwise direction of the plurality of circuit boards, each comprising a light-emitting diode chip disposed in the first groove and electrically connected to one of the plurality of circuit boards; and
a container which is configured to accommodate the plurality of circuit boards therein.

15. The backlight assembly of claim 14, wherein lateral surface of the optical lens further comprises a plurality of lateral flat portions disposed along the widthwise direction of the plurality of circuit boards and comprising:
in a cross-sectional view,
a first lateral flat portion perpendicular to the lower flat portion of the bottom surface, and
a second lateral flat portion parallel to the first lateral flat portion.

16. The backlight assembly of claim 14, wherein the lateral surface of the optical lens further comprises a plurality of lateral flat portions disposed along the widthwise direction of the plurality of circuit boards and comprising:
in a cross-sectional view,
a first lateral flat portion perpendicular to the lower flat portion of the bottom surface, and
a second lateral flat portion inclined at an inclination angle of about 90° or less with respect to the lower flat portion of the bottom surface.

17. The backlight assembly of claim 14, wherein the lateral surface of the optical lens further comprises a plurality of lateral flat portions disposed along the widthwise direction of the plurality of circuit boards and comprising:
in a cross-sectional view,
a first lateral flat portion inclined at an inclination angle of about 90° or less with respect to the lower flat portion of the bottom surface, and
a second lateral flat portion inclined at an inclination angle of about 90° or less with respect to the lower flat portion of the bottom surface.

18. The backlight assembly of claim 14, wherein
the lateral surface of the optical lens further comprises a second lateral curved portion aligned with the lateral flat portion along the widthwise direction of the plurality of circuit boards, and
the lateral flat portion is perpendicular to the lower flat portion of the bottom surface, in a cross-sectional view.

19. The backlight assembly of claim 14, wherein
the lateral surface of the optical lens further comprises a second lateral curved portion aligned with the lateral flat portion along the widthwise direction of the plurality of circuit boards, and
the lateral flat portion is inclined at an inclination angle of about 90° or less with respect to the lower flat portion of the bottom surface, in a cross-sectional view.

20. The backlight assembly of claim 14, wherein
the plurality of circuit boards comprises an uppermost circuit board, an intermediate circuit board and a lowermost circuit board, sequentially in a top plan view,
for each light source unit on the uppermost circuit board, the lateral flat portion faces the lowermost circuit board,
for each light source unit on the lowermost circuit board, the lateral flat portion faces the uppermost circuit board, and
for each light source unit disposed on the intermediate circuit board, the optical lens further comprises a plurality of lateral flat portions comprising first and second lateral flat portions aligned in the widthwise direction of the plurality of circuit boards.
